(19) United States
(12) Patent Application Publication
(10) Pub. No.: US 2026/0276504 A1
(43) Pub. Date: Sep. 17, 2026

(54) CONTINUOUS-JET RAIN EROSION TESTING DEVICE FOR MATERIALS

(71) Applicant: NORTHWESTERN POLYTECHNICAL UNIVERSITY, Xi'an (CN)

(72) Inventors: Qingbo DOU, Xi'an (CN); Tao SUO, Xi'an (CN); Zheng SHI, Xi'an (CN)

(21) Appl. No.: 19/181,795

(22) Filed: Apr. 17, 2025

(30) Foreign Application Priority Data
Mar. 14, 2025 (CN) 202510304012.1

(51) Int. Cl. G01N 3/56

(52) U.S. Cl. CPC G01N 3/567; G01N 3/56; G01N 17/00; G01N 17/02; G01N 17/04; G01N 17/043

(57) ABSTRACT

A continuous-jet rain erosion testing device for materials is provided, including a frame, an impact assembly and a jet assembly. The impact assembly includes a ram acceleration component and a drive component, the ram acceleration component and the drive component are respectively arranged on the frame, one end of the ram acceleration component is connected to the drive component; where when the drive component is in a first motion state, the ram acceleration component is driven to rotate counterclockwise around a connection point with the frame; and when the drive component is in a second motion state, the ram acceleration component resets clockwise. The jet assembly includes a jet generation component and a support table, the jet generation component is installed on a top of the support table.

### CROSS-REFERENCE TO RELATED APPLICATIONS

This application claims priority to Chinese Patent Application No. 202510304012.1, filed on Mar. 14, 2025, the contents of which are hereby incorporated by reference.

### TECHNICAL FIELD

The present disclosure relates to the technical field of testing and inspection devices, and in particular relates to a continuous-jet rain erosion testing device for materials.

### BACKGROUND

High-speed moving objects in rainy environments may cause high-speed impacts between the object and raindrops, which may damage the surface material of the object. This phenomenon of high-speed liquid-solid impact accompanied by surface erosion is referred to as “rain erosion”. The surface damage of materials caused by rain erosion may damage certain structures of the object, affect its effectiveness, and even destroy the structural strength of the object. Simulating the impact of a single raindrop on a material may help study the damage behavior and damage evolution of the materials impacted by continuous single raindrop. However, during heavy rainfall, the multi-raindrop coupling impact is prone to occur. This coupling may alter the internal stress state of the solid. Therefore, it is necessary to simulate the working conditions of such multi-droplet coupling impacts.

Continuous droplet testing methods include single-droplet continuous testing methods and multi-droplet continuous testing methods, which may be used to study the damage evolution process of materials under single-droplet continuous impacts or multi-droplet coupling continuous impacts. In the prior art, the single-droplet continuous testing methods simulate raindrop shapes that do not match actual conditions, and the shape and size of the raindrops are difficult to control. The multi-droplet continuous testing methods also face technical limitations, making it difficult to conduct research on multi-droplet coupling impacts.

Therefore, there is an urgent need for a continuous-jet rain erosion testing device for materials to address the aforementioned issues.

### SUMMARY

An objective of the present disclosure is to provide a continuous-jet rain erosion testing device for materials to solve the problems existing in the prior art.

To achieve the above objective, the present disclosure provides the following solution: the present disclosure provides a continuous-jet rain erosion testing device for materials, including:
a frame;
an impact assembly, including a ram acceleration component and a drive component, where the ram acceleration component and the drive component are respectively arranged on the frame, and one end of the ram acceleration component is connected to the drive component; where when the drive component is in a first motion state, the ram acceleration component is driven to rotate counterclockwise around a connection point with the frame; and when the drive component is in a second motion state, the ram acceleration component resets clockwise; and
a jet assembly, including a jet generation component and a support table, where the jet generation component is installed on a top of the support table; and when the ram acceleration component resets, the other end of the ram acceleration component impacts the jet generation component to generate a high-speed jet, and the generated high-speed jet impacts a test piece.

According to the continuous-jet rain erosion testing device for materials provided by the present disclosure, the ram acceleration component includes:
a lever rotatably connected to the frame through a rotating shaft, where a bottom of one end of the lever is fixedly connected to a ram;
a hanging ring hinged to a bottom of the other end of the lever, where the hanging ring is connected to the drive component through a belt; and
a tension spring, where one end of the tension spring is hinged to a top of the other end of the lever, and the other end of the tension spring is hinged to the frame.

According to the continuous-jet rain erosion testing device for materials provided by the present disclosure, the drive component includes:
a rotating wheel rotatably connected to the frame, where the rotating wheel is fixedly connected to one end of the belt;
a transmission shaft rotatably connected to a middle of the rotating wheel, where two ends of the transmission shaft are fixedly connected to a rebound lever and a belt pulley respectively, and the belt pulley is connected to an output end of a motor through a transmission belt; and
a pin arranged on the rotating wheel and in contact with the rebound lever. When the rebound lever rotates, the rotating wheel is driven to rotate through the pin.

According to the continuous-jet rain erosion testing device for materials provided by the present disclosure, the rotating wheel is provided with multiple through holes arranged at equal intervals in a circumferential direction, and the pin is detachably connected to the through holes.

According to the continuous-jet rain erosion testing device for materials provided by the present disclosure, the rebound lever includes a fixed plate and a rebound plate, where the fixed plate is fixedly connected to the transmission shaft, the rebound plate is in contact with the pin, and the rebound plate is hinged to the fixed plate through a rebound hinge; a sliding boss is fixedly connected to the frame, and a pushing block is fixedly connected to the rebound plate; and where when the pushing block contacts the sliding boss, the rebound plate rotates around the rebound hinge, causing the rebound plate to separate from the pin.

According to the continuous-jet rain erosion testing device for materials provided by the present disclosure, the jet generation component includes:
a nozzle embedded in the support table through a cover plate, where a top of the nozzle is fixedly connected to a lower boss, a top of the lower boss is fixedly connected to an upper boss, and a gap is provided between the lower boss and the upper boss; and
an impact shaft slidably connected inside the nozzle, where the nozzle is supplied with water by a water supply device; and when the impact shaft is impacted by the ram, the water inside the nozzle generates the high-speed jet.

A top of the impact shaft is a boss structure, and the boss structure is located in the gap.

According to the continuous-jet rain erosion testing device for materials provided by the present disclosure, a guide sleeve is fixedly connected inside the lower boss, and the guide sleeve is sleeved on the impact shaft; and a reset spring is sleeved on the guide sleeve, one end of the reset spring is fixedly connected to a bottom of the boss structure, and another end of the reset spring is fixedly connected to the lower boss.

According to the continuous-jet rain erosion testing device for materials provided by the present disclosure, the water supply device includes:
a water storage tank connected to a water supply joint through a silicone hose, where the water supply joint is in communication with the nozzle; and
a peristaltic pump installed on the silicone hose.

According to the continuous-jet rain erosion testing device for materials provided by the present disclosure, the device further includes a test piece fixture, where the test piece fixture includes an installation platform, and the installation platform is installed on the support table through a universal joint, and the installation platform is located below the nozzle, and the test piece is installed on the installation platform.

The support table is provided with a water removal device, where the water removal device includes a high-pressure air source fixedly connected to the support table, and the high-pressure air source is provided with an air nozzle through an electromagnetic valve, and the air nozzle is configured for blowing air to the test piece.

According to the continuous-jet rain erosion testing device for materials provided by the present disclosure, the nozzle includes:
a cylindrical hole, where a bottom of the cylindrical hole is in communication with a fine hole through a transition inclined surface; and
a water supply hole located at one side of the cylindrical hole and is in communication with the cylindrical hole, where the water supply hole is in communication with the water supply joint.

A groove is provided at a top of the cylindrical hole, and a sealing ring is arranged in the groove.

Compared with the prior art, the present disclosure has the following advantages and technical effects.

The present disclosure provides the continuous-jet rain erosion testing device for materials, when in use, the ram acceleration component in a horizontal state initially. When the drive component is in the first motion state, the provided drive component pulls the ram acceleration component to rotate counterclockwise. When the rotation of the drive component reaches a certain angle, the drive component enters the second motion state. At this time, the drive component no longer applies a downward pulling force to the ram acceleration component, and the ram acceleration component resets clockwise. During the clockwise resetting, the other end impacts the jet generation component, enabling the jet generation component to generate a high-speed jet, so as to impact the test piece. By repeating the above process, continuous jets are achieved. Additionally, by adjusting the switching time between the first motion state and the second motion state of the drive component and the resetting tension of the ram acceleration component, the speed of the jet may be controlled. Moreover, the angle between the jet and the test piece may be adjusted to simulate impacts at different angles, thereby meeting different testing requirements. The present disclosure has a simple structure, low cost, and wide applicability. The present disclosure may generate well-formed, variable-speed, and variable-frequency continuous jets, simulating the continuous raindrop impacts encountered during aircraft flight. At the same time, the angle between the test piece and the jet can be adjusted to realize the impact simulation at different angles, thus meeting different test requirements.

### BRIEF DESCRIPTION OF THE DRAWINGS

In order to explain the embodiments of the present disclosure or the technical solution in the prior art more clearly, the drawings needed in the embodiments will be briefly introduced below. Apparently, the drawings in the following description are only some embodiments of the present disclosure. For one of ordinary skill in the art, other drawings may be obtained according to these drawings without creative effort:

FIG. 1 is a schematic diagram of an overall structure of a testing device according to the present disclosure.

FIG. 2 is a front view of the testing device according to the present disclosure.

FIG. 3 is a schematic diagram of a ram acceleration component in an initial state according to the present disclosure.

FIG. 4 is a schematic diagram of an overall structure of a drive component according to the present disclosure.

FIG. 5 is a side view of the drive component according to the present disclosure.

FIG. 6 is a cross-sectional view of a jet generation component taken along the line A-A shown in FIG. 2.

FIG. 7 is a schematic structural diagram of a nozzle according to one embodiment of the present disclosure.

FIG. 8 is a schematic structural diagram of a nozzle according to another embodiment of the present disclosure.

### DETAILED DESCRIPTION OF THE EMBODIMENTS

In the following, the technical solutions in the embodiments of the present disclosure will be clearly and completely described with reference to the attached drawings. Apparently, the described embodiments are only a part of the embodiments of the present disclosure, but not all the embodiments. Based on the embodiments in the present disclosure, all other embodiments obtained by one of ordinary skill in the art without creative effort belong to the protection scope of the present disclosure.

In order to make the above objects, features and advantages of the present disclosure more obvious and easier to understand, the present disclosure will be further described in detail with the attached drawings and specific embodiments.

### Embodiment 1

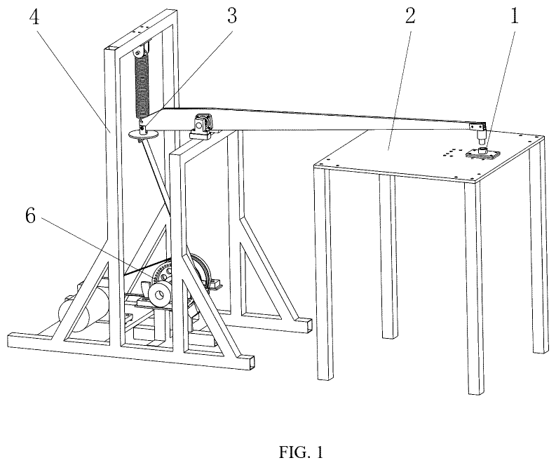

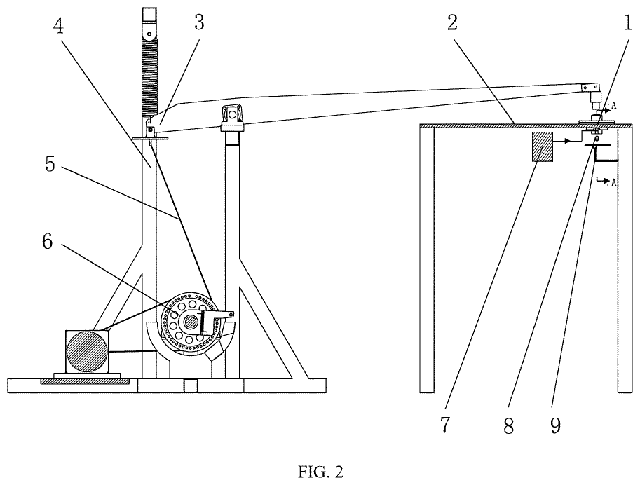

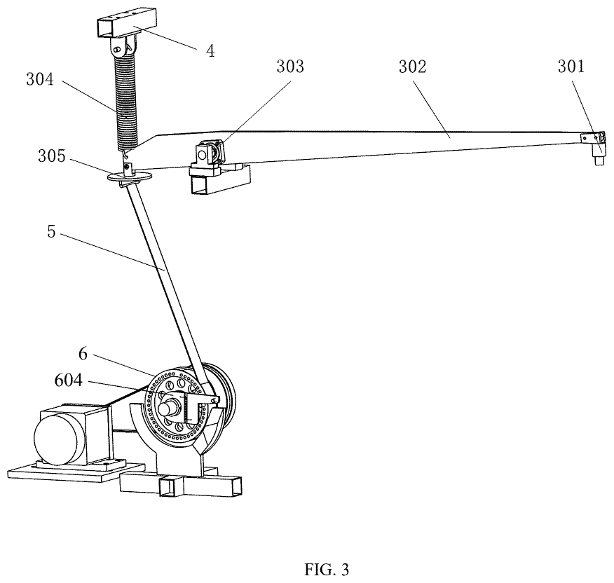

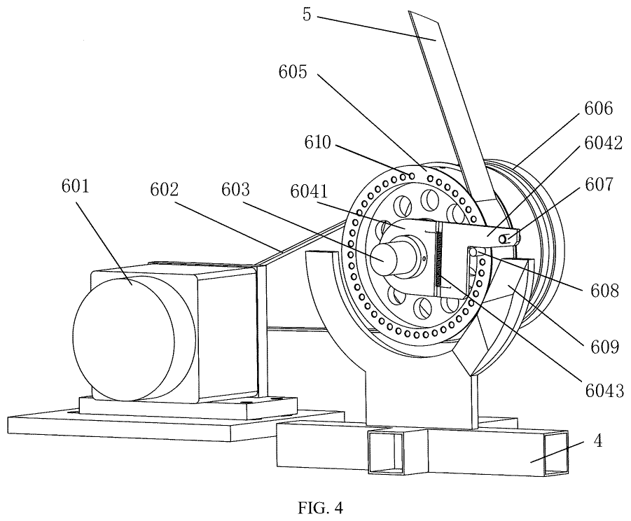

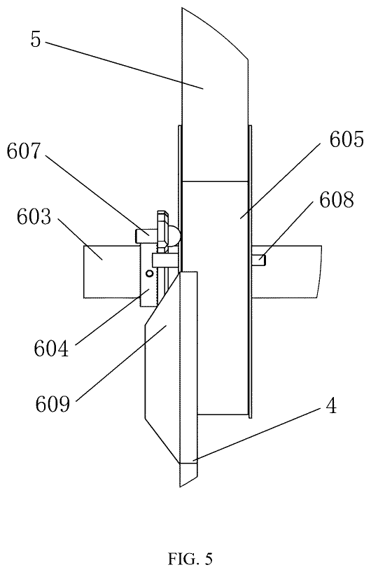

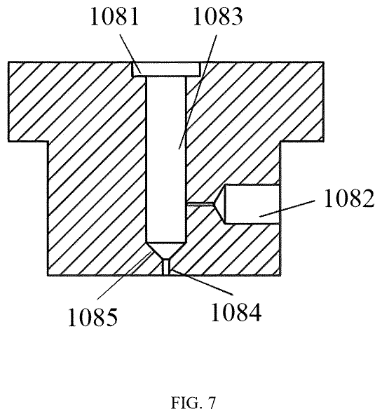

With reference to FIG. 1 to FIG. 7, the present disclosure provides a continuous-jet rain erosion testing device for materials, including a frame 4, an impact assembly and a jet assembly.

The impact assembly includes a ram acceleration component 3 and a drive component 6. The ram acceleration component 3 and the drive component 6 are respectively arranged on the frame 4, and one end of the ram acceleration component 3 is connected to the drive component 6. When the drive component 6 is in the first motion state, the ram acceleration component 3 is driven to rotate counterclockwise around a connection point with the frame 4, and when the drive component 6 is in the second motion state, the ram acceleration component 3 resets clockwise.

The jet assembly includes a jet generation component 1 and a support table 2 The jet generation component 1 is installed on the top of the support table 2. When the ram acceleration component 3 resets towards the initial position, the other end of the ram acceleration component 3 impacts the jet generation component 1 to generate a high-speed jet, and the generated high-speed jet impacts the test piece.

In this embodiment of the present disclosure, when in use, the ram acceleration component 3 is initially in a horizontal state. When the drive component 6 is in the first motion state, the set drive component 6 pulls the ram acceleration component 3 to rotate counterclockwise. When the rotation of the drive component reaches a certain angle, the drive component 6 enters the second motion state. At this time, the drive component 6 no longer applies a downward pulling force to the ram acceleration component 3, and the ram acceleration component 3 resets clockwise. During the clockwise resetting, the other end impacts the jet generation component 1, causing the jet generation component 1 to generate a high-speed jet that impacts the test piece, and the jet test is completed.

In this embodiment, the ram acceleration component 3 includes a lever 302, a hanging ring 305 and a tension spring 304.

The lever 302 is rotatably connected to the frame 4 through a rotating shaft 303, the bottom of one end of the lever 302 is fixedly connected to a ram 301.

The hanging ring 305 is hinged to the bottom of the other end of the lever 302, the hanging ring 305 is connected to the drive component 6 through a belt 5.

One end of the tension spring 304 is hinged to the top of the other end of the lever 302, and the other end of the tension spring 304 is hinged to the frame 4.

In this embodiment of the present disclosure, the lever 302 is rotatably connected to the frame 4. When the drive component 6 pulls the hanging ring 305 downward through the belt 5, the lever 302 is driven to rotate counterclockwise about the hinge point. When the drive component 6 releases the force on the hanging ring 305, the lever 302 resets clockwise through the tension spring 304, causing the ram 301 to impact the jet generation component 1 to generate a high-speed jet.

In this embodiment, the drive component 6 includes a rotating wheel 605, a transmission shaft 603 and a pin 608.

The rotating wheel 605 is rotatably connected to the frame 4, one end of the belt 5 is fixedly connected to the rotating wheel 605.

The transmission shaft 603 is rotatably connected to the middle of the rotating wheel 605, two ends of the transmission shaft 603 are fixedly connected to a rebound lever 604 and a belt pulley 606 respectively, and the belt pulley 606 is connected to the output end of a motor 601 through a transmission belt 602.

The pin 608 is arranged on the rotating wheel 605 and in contact with the rebound lever 604. When the rebound lever 604 rotates, the rotating wheel 605 is driven to rotate through the pin 608.

In this embodiment of the present disclosure, the motor 601 drives the belt pulley 606 to rotate, and the belt pulley 606 synchronously drives the rebound lever 604 to rotate. The rebound lever 604 comes into contact with the pin 608, as the rebound lever 604 rotates, the rotating wheel 605 is driven to rotate through the pin 608. The rotation of the rotating wheel 605 pulls the lever 302 to rotate counterclockwise through the belt 5.

In this embodiment, the rotating wheel 605 is provided with multiple through holes 610 arranged at equal intervals in the circumferential direction, and the pin 608 is detachably connected to the through holes 610.

In this embodiment of the present disclosure, the jet speed is controlled by inserting the pin 608 into the corresponding through hole 610.

In this embodiment, the rebound lever 604 includes a fixed plate 6041 and a rebound plate 6042. The fixed plate 6041 is fixedly connected to the transmission shaft 603, and the rebound plate 6042 is in contact with the pin 608. The rebound plate 6042 is hinged to the fixed plate 6041 through a rebound hinge 6043. A sliding boss 609 is fixedly connected to the frame 4, and a pushing block 607 is fixedly connected to the rebound plate 6042. When the pushing block 607 contacts the sliding boss 609, the rebound plate 6042 rotates around the rebound hinge 6043, causing the rebound plate 6042 to separate from the pin 608. After the rebound plate 6042 separates from the pin 608, the rotating wheel 605 is rotated back and reset by the belt 5 and the tension spring 304, the above steps is repeated cyclically, thereby achieving continuous swinging of the lever 302 and the continuous jet.

In this embodiment of the present disclosure, the rebound lever 604 has a split structure, with the fixed plate 6041 and the rebound plate 6042 hinged through the rebound hinge 6043. In the initial state, the fixed plate 6041 and the rebound plate 6042 are in a plane. At this time, the rebound plate 6042 may drive the pin 608 to rotate synchronously, thereby driving the rotating wheel 605 to rotate. When the pushing block 607 on the rebound plate 6042 comes into contact with the sliding boss 609 and slides thereon, the rebound plate 6042 will be gradually bent about the rebound hinge, causing the rebound plate 6042 to separate from the pin 608.

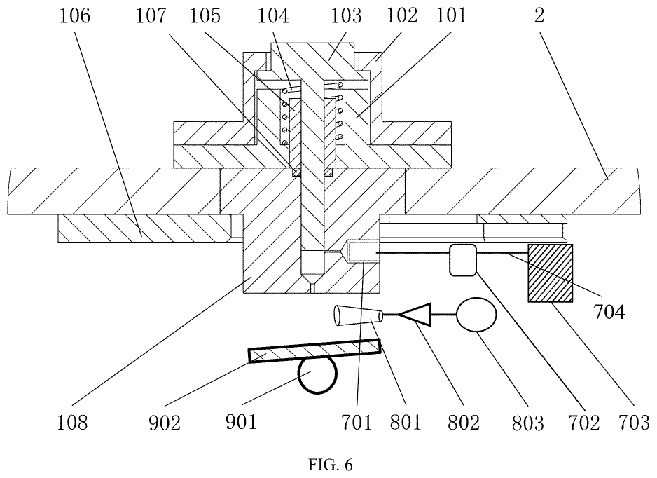

In this embodiment, as shown in FIG. 6, the jet generation component 1 includes a nozzle 108 and an impact shaft 103.

The nozzle 108 is embedded in the support table 2 through a cover plate 106, the top of the nozzle 108 is fixedly connected to a lower boss 101, the top of the lower boss 101 is fixedly connected to an upper boss 102, and a gap is provided between the lower boss 101 and the upper boss 102.

The impact shaft 103 is slidably connected inside the nozzle 108, the nozzle 108 is supplied with water by a water supply device 7. When the impact shaft 103 is impacted by the ram 301, the water inside the nozzle 108 generates the high-speed jet.

The top of the impact shaft 103 has a boss structure, and the boss structure is located in the gap.

In this embodiment of the present disclosure, the nozzle 108 is embedded in the table surface of the support table 2, and water is supplied to the nozzle 108 through the water supply device 7. The ram 301 impacts the impact shaft 103, causing the water inside the nozzle 108 to be ejected from the bottom of the nozzle 108, generating the high-speed jet. The lower boss 101 and the upper boss 102 are provided to limit the impact shaft 103.

In this embodiment, a guide sleeve 105 is fixedly connected inside the lower boss 101, and the guide sleeve 105 is sleeved on the impact shaft 103. A reset spring 104 is sleeved on the guide sleeve 105, and one end of the reset spring 104 is fixedly connected to the bottom of the boss structure, and the other end of the reset spring 104 is fixedly connected to the lower boss 101.

In this embodiment of the present disclosure, when the impact shaft 103 moves downward, the reset spring 104 is compressed. Conversely, when the ram 301 separates from the impact shaft 103, the reset spring 104 drives the impact shaft 103 to reset.

In this embodiment, the water supply device 7 includes a water storage tank 703 and a peristaltic pump 702.

The water storage tank 703 is connected to a water supply joint 701 through a silicone hose 704, the water supply joint 701 is in communication with the nozzle 108.

The peristaltic pump 702 is installed on the silicone hose.

In this embodiment of the present disclosure, the water storage tank 703 stores water, and the water is delivered to the nozzle 108 through the peristaltic pump 702 and the water supply joint 701.

In this embodiment, the device further includes a test piece fixture 9. The test piece fixture 9 includes an installation platform 902, the installation platform 902 is installed on the support table 2 through a universal joint 901, and the installation platform 902 is located below the nozzle 108, and the test piece is installed on the installation platform 902.

The support table 2 is provided with a water removal device 8, and the water removal device 8 includes a high-pressure air source 803 fixedly connected to the support table 2. The high-pressure air source 803 is provided with an air nozzle 801 through an electromagnetic valve 802, and the air nozzle 801 is used for blowing air to a test piece.

In this embodiment of the present disclosure, the installation platform 902 is used to install the test piece, and the angle of the installation platform 902 may be adjusted by the universal joint 901 to achieve a predetermined impact angle.

In this embodiment of the present disclosure, since it is difficult to accurately control the amount of water supplied in the nozzle 108, the excess water will flow out of the nozzle outlet and form a water film on the test piece. It is necessary to use the air nozzle 801 to blow high-pressure air to remove the excess water at the nozzle outlet and the water film on the surface of the test piece.

In this embodiment, the nozzle 108 includes a cylindrical hole 1083 and a water supply hole 1082.

The bottom of the cylindrical hole 1083 is in communication with a fine hole 1084 through a transition inclined surface 1085 (i.e., a tapered surface).

The water supply hole 1082 is located at one side of the cylindrical hole 1083 and is in communication with the cylindrical hole 1083, the water supply hole 1082 is in communication with the water supply joint 701.

A groove 1081 is provided at the top of the cylindrical hole 1083, and a sealing ring 107 is arranged in the groove 1081.

In this embodiment of the present disclosure, the impact shaft 103 is slidably connected in the cylindrical hole 1083, and the water supply joint 701 is in communication with the water supply hole 1082 to deliver water into the cylindrical hole 1083. The ram 301 impacts the impact shaft 103, causing the impact shaft 103 to move downward at high speed inside the cylindrical hole 1083, ejecting water from the nozzle 108 to form a jet. The groove 1081 is provided for installing the sealing ring 107.

In this embodiment of the present disclosure, fine holes 1084 of different diameters may be selected to generate jets of different diameters for simulating the impact of liquid droplets of different diameters.

In this embodiment of the present disclosure, the motor 601, the peristaltic pump 702, and the electromagnetic valve 802 are electrically connected to a programmable logic controller (PLC) controller.

The present disclosure provides the continuous-jet rain erosion testing device for materials, which, when in use, operates as follows.

Manual operation sends an instruction to the PLC controller to start the drive component 6 by starting the motor 601, and at the same time, the water supply device 7 starts to work, so as to supply water to the jet generation component 1. The torque output by the motor 601 is transmitted to the belt pulley 606 through the transmission belt 602, driving the belt pulley 606 to rotate. The belt pulley 606 drives the transmission shaft 603 to rotate, and in turn drives the rebound lever 604 to rotate synchronously. During the rotation of the rebound lever 604 about the transmission shaft, it contacts the pin 608 on the rotating wheel 605, thereby driving the rotating wheel 605 to rotate. The rotation of the rotating wheel 605 tightens and winds the belt 5 around the outer circumference of the rotating wheel 605. The tension of the belt 5 drives the lever 302 to rotate counterclockwise, while the tension spring 304 is stretched and stores energy. When the pushing block 607 at the front end of the rebound lever 604 moves to a certain position on the sliding boss 609, the bending of the rebound lever 604 reaches a certain degree, causing the rebound lever 604 to separate from the pin 608. At this point, the water supply device 7 stops working, and the water removal device 8 operates. The air nozzle 801 blows air for a short period, and the tension of the belt 5 disappears. The lever 302 accelerates clockwise under the action of the tension spring 304, and the ram 301 impacts the impact shaft 103, generating one jet from the nozzle 108. Subsequently, the belt pulley 606 continues to rotate, and the drive component 6 continues to work, and the above process is repeated cyclically, so that the jet may be generated continuously for many times.

### Embodiment 2

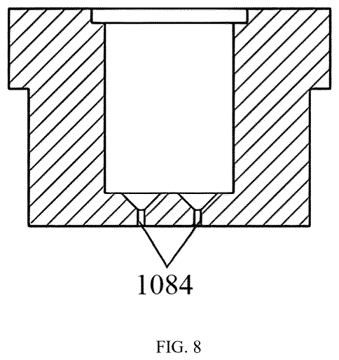

With reference to FIG. 8, in this embodiment, multiple fine holes 1084 are provided, each fine hole is in communication with the cylindrical hole 1083 through the transition inclined surface 1085.

In this embodiment, by setting the multiple fine holes 1084, multiple jets may be generated simultaneously in a single impact, which may be used to simulate the material response when multiple droplets simultaneously impact the test piece.

In the description of the present disclosure, it should be understood that the terms “longitudinal”, “transverse”, “up”, “down”, “front”, “back”, “left”, “right”, “vertical”, “horizontal”, “top”, “bottom”, “inside”, “outside”, etc. indicate orientation or positional relationships based on the orientation or positional relationships shown in the accompanying drawings, only for the convenience of describing the present disclosure, and do not indicate or imply that the device or element referred to must have a specific orientation, be constructed and operated in a specific orientation, and therefore cannot be understood as a limitation of the present disclosure.

The above-mentioned embodiments only describe the preferred mode of the present disclosure, and do not limit the scope of the present disclosure. Under the premise of not departing from the design spirit of the present disclosure, various modifications and improvements made by one of ordinary skill in the art to the technical solution of the present disclosure should fall within the protection scope of the present disclosure.

1. A continuous-jet rain erosion testing device for materials, comprising:
a frame;
an impact assembly, comprising a ram acceleration component and a drive component, wherein the ram acceleration component and the drive component are respectively arranged on the frame, and one end of the ram acceleration component is connected to the drive component; and wherein when the drive component is in a first motion state, the ram acceleration component is driven to rotate counterclockwise around a connection point with the frame; and when the drive component is in a second motion state, the ram acceleration component resets clockwise; and
a jet assembly, comprising a jet generation component and a support table, wherein the jet generation component is installed on a top of the support table; and when the ram acceleration component resets, another end of the ram acceleration component impacts the jet generation component to generate a high-speed jet, and the generated high-speed jet impacts a test piece; and
wherein the ram acceleration component comprises: a lever rotatably connected to the frame through a rotating shaft, wherein a bottom of one end of the lever is fixedly connected to a ram; a hanging ring hinged to a bottom of another end of the lever, wherein the hanging ring is connected to the drive component through a belt; and a tension spring, wherein one end of the tension spring is hinged to a top of the other end of the lever, and another end of the tension spring is hinged to the frame; the drive component comprises: a rotating wheel rotatably connected to the frame, wherein the rotating wheel is fixedly connected to one end of the belt; a transmission shaft rotatably connected to a middle of the rotating wheel, wherein two ends of the transmission shaft are fixedly connected to a rebound lever and a belt pulley respectively, and the belt pulley is connected to an output end of a motor through a transmission belt; and a pin arranged on the rotating wheel and in contact with the rebound lever; wherein when the rebound lever rotates, the rotating wheel is driven to rotate through the pin; and the rotating wheel is provided with a plurality of through holes arranged at equal intervals in a circumferential direction, and the pin is detachably connected to the through holes; and
wherein the rebound lever comprises a fixed plate and a rebound plate, wherein the fixed plate is fixedly connected to the transmission shaft, the rebound plate is in contact with the pin, and the rebound plate is hinged to the fixed plate through a rebound hinge; a sliding boss is fixedly connected to the frame, and a pushing block is fixedly connected to the rebound plate; and wherein when the pushing block contacts the sliding boss, the rebound plate rotates around the rebound hinge, causing the rebound plate to separate from the pin.

2-5. (canceled)

6. The continuous-jet rain erosion testing device for materials according to claim 1, wherein the jet generation component comprises:
a nozzle embedded in the support table through a cover plate, wherein a top of the nozzle is fixedly connected to a lower boss, a top of the lower boss is fixedly connected to an upper boss, and a gap is provided between the lower boss and the upper boss; and
an impact shaft slidably connected inside the nozzle, wherein the nozzle is supplied with water by a water supply device; and when the impact shaft is impacted by the ram, the water inside the nozzle generates the high-speed jet; and
wherein a top of the impact shaft is a boss structure, and the boss structure is located in the gap.

7. The continuous-jet rain erosion testing device for materials according to claim 6, wherein a guide sleeve is fixedly connected inside the lower boss, and the guide sleeve is sleeved on the impact shaft; and a reset spring is sleeved on the guide sleeve, one end of the reset spring is fixedly connected to a bottom of the boss structure, and another end of the reset spring is fixedly connected to the lower boss.

8. The continuous-jet rain erosion testing device for materials according to claim 6, wherein the water supply device comprises:
a water storage tank connected to a water supply joint through a silicone hose, wherein the water supply joint is in communication with the nozzle; and
a peristaltic pump installed on the silicone hose.

9. The continuous-jet rain erosion testing device for materials according to claim 6, further comprising a test piece fixture, wherein the test piece fixture comprises an installation platform, and the installation platform is installed on the support table through a universal joint, and the installation platform is located below the nozzle, and the test piece is installed on the installation platform; and
wherein the support table is provided with a water removal device, wherein the water removal device comprises a high-pressure air source fixedly connected to the support table, and the high-pressure air source is provided with an air nozzle through an electromagnetic valve, and the air nozzle is configured for blowing air to the test piece.

10. The continuous-jet rain erosion testing device for materials according to claim 8, wherein the nozzle comprises:
a cylindrical hole, wherein a bottom of the cylindrical hole is in communication with a fine hole through a transition inclined surface; and
a water supply hole located at one side of the cylindrical hole and in communication with the cylindrical hole, wherein the water supply hole is in communication with the water supply joint; and
wherein a groove is provided at a top of the cylindrical hole, and a sealing ring is arranged in the groove.
